(19) United States
(12) Patent Application Publication
(10) Pub. No.: US 2025/0196961 A1
(43) Pub. Date: Jun. 19, 2025

(54) VEHICLE FOR ONE RIDER, HAVING A BALL ROLLING ON THE GROUND

(71) Applicant: Innovated Transport Systems UG, Essen (DE)

(72) Inventor: Ulrich Sambeth, Essen (DE)

(21) Appl. No.: 18/836,479

(22) PCT Filed: Feb. 6, 2023
(86) PCT No.: PCT/EP2023/052830

§ 371 Date: Aug. 7, 2024

(30) Foreign Application Priority Data
Feb. 8, 2022 (DE) 10 2022 102 908.5

(51) Int. Cl. B62K 11/00; B62K 1/00

(52) U.S. Cl. CPC B62K 11/007; B62K 1/00

(57) ABSTRACT

A vehicle for carrying one rider, having a ball rolling on the ground, a bearing element unstably supported on the ball, on which bearing element the rider stands in a balancing manner during operation of the vehicle, a drive assembly supported against the bearing element, which drive assembly drives the ball, and a controller via which the drive assembly can be controlled in a desired direction of travel in dependence upon the inclination of the bearing element and the direction of inclination of the bearing element. In order to create a particularly compact vehicle, the drive assembly comprises four omni wheels, of which at least two omni wheels have a tilt angle.

### CROSS REFERENCE TO RELATED APPLICATION

The present application is a national stage application of International Patent Application No. PCT/EP2023/052830, filed Feb. 6, 2023, and claims benefit of German patent application no. 10 2022 102 908.5, filed Feb. 8, 2022.

### BACKGROUND AND FIELD OF THE INVENTION

The invention relates to a vehicle for the locomotion of a rider, having a ball rolling on a ground surface, having a carrying element unstably supported on the ball, on which carrying element the rider stands in a balancing manner during operation of the vehicle, having a drive arrangement which is supported on the carrying element and drives the ball, and having a controller, by means of which the drive arrangement can be controlled in a desired direction of travel in dependence upon the inclination of the carrying element and of the direction of inclination of the carrying element.

A vehicle for locomotion of a rider, in particular a skateboard-like ball castor, is already known from European patent EP 3 043 877 B1. The vehicle essentially consists of a ball rolling on a ground surface, a carrying element supported on the ball and having two stand-on surfaces, one for each foot of the rider, a drive arrangement and a controller. In one embodiment, the drive arrangement is essentially built up from a total of four omni-wheels, three of which are combined into a group and roll on the upper half of the ball, and the fourth of which rolls along an equator of the ball. All the omni-wheels stand in each case without an angle of tilt on the surface of the ball so that when the carrying element is orientated horizontally the respective axes of rotation of the three omni-wheels of the group are horizontal and the axis of rotation of the fourth omni-wheel is orientated vertically. The carrying element is predominantly supported on the ball via the group of three omni-wheels. With the aid of the fourth omni-wheel, the carrying element can be rotated about a vertical axis of the ball. The ball can therefore roll in all directions on the ground surface below or in the carrying element which is located at an equator of the ball. In addition to the support function, all the omni-wheels assume a driving function. For this purpose, the omni-wheels are each driven via electric motors and upstream transmissions which are mounted on the carrying element. In order to use the vehicle, which can also be referred to as a sports device, leisure device or fun device, the rider stands in a freely balancing manner on the carrying element and controls, brakes and steers the vehicle by shifting his weight. The rider is assisted therein by the controller which comprises, inter alia, a balance control module which assists the rider in balancing the carrying element in a horizontal position. The direction of movement of the vehicle and therefore the rolling direction of the ball is controlled via the inclination of the carrying element, which is induced by the shifting of the rider's weight. The measured acceleration data and angle data of the carrying element are processed in the controller, based thereon it is determined which of the motors of the respective omni-wheels are to be driven, and a desired travel movement and the balance position are achieved with the required direction of rotation and rotational speed. The vehicle is fitted with three rechargeable batteries for the motors and the controller, which are disposed on the lower side of the carrying element around the ball.

The further European patent EP 3 378 540 B1 discloses a comparable vehicle with a ball, a carrying element and a group of three driven omni-wheels. These three omni-wheels also roll on the upper half of the ball and their axes of rotation are orientated in different directions. In addition, the vehicle comprises, on the carrying element, a centrally placed handle which the rider can hold onto. In addition, a control means is disposed on the upper end of the handle and is designed as a control stick, joystick or rocker switch, by means of which a so-called forward direction of the vehicle can be set. Using the control means, the forward direction of the vehicle can be set in such a way that this direction corresponds to the desired direction of travel and therefore the rider is looking in the direction of travel without turning his head.

A so-called dynamically balancing ball scooter for personal transportation is known from the Dutch patent NL 1033676 C2 and makes locomotion of a rider possible by means of a ball filled with compressed air. This ball scooter also comprises a holding bar with a steering handle for the rider. The rider stands on a carrying element which is disposed over the ball. The ball is driven by a total of three pairs of omni-wheels which are each folded against the surface of the ball at a fold angle. Two pairs roll on the upper half of the ball and the third pair, in an opposing manner, rolls on the lower half of the ball.

Korean patent KR 10-1269628 B1 discloses a further portable ball scooter for personal transportation, having a ball which is supported on a carrying element formed as a plate, and a holding bar with a steering handle. The carrying element comprises a centrally placed opening, through which only a small part of the upper half of the ball protrudes upwards. The ball is driven via four drive motors fitted with upstream transmissions and with drive rollers which are each supported on the carrying element. The drive rollers are placed against the surface of the ball without an angle of tilt, with a vertical rolling direction and at the equator. As seen in the circumferential direction of the ball, the respectively adjacent drive rollers are uniformly spaced apart from each other. The axes of rotation of the drive rollers are each orientated horizontally when the carrying element is orientated horizontally. Furthermore, each drive wheel is allocated an auxiliary ball which is disposed outwardly offset from the ball via the respective drive roller and is intended to prevent the ball scooter from tipping over. The possibility of a rotational movement of the carrying element about a vertical axis by means of the drive motors is not described.

A comparable arrangement of omni-wheels in relation to a drive of a ball of a travelling robot is known from the American patent U.S. Pat. No. 8,308,604 B2. The four omni-wheels engage against the upper half of the ball at a common height, in each case without an angle of tilt and with horizontal axes of rotation. As seen in the circumferential direction of the ball, the respectively adjacent omni-wheels are uniformly spaced apart from each other.

Furthermore, from the international laid-open document WO 2020 110 651 A1 a drive arrangement with three balls rolling on a ground surface is known. The balls are disposed in the corners of a notional triangle and are driven by three drive wheels. In this case, the drive wheels are each in engagement with two adjacent balls.

Furthermore, U.S. patent U.S. Pat. No. 10,189,342 B2 discloses a robot balancing on a single ball. The ball is driven via three drive wheels distributed around the circumference of the ball.

### SUMMARY OF THE INVENTION

The present invention provides an improved compact vehicle for the locomotion of a rider, having a ball rolling on a ground surface for unlimited movability in all directions.

In accordance with an embodiment of the invention, a particularly compact vehicle for the locomotion of a rider, having a ball rolling on a ground surface, having a carrying element unstably supported on the ball, on which carrying element the rider stands in a balancing manner during operation of the vehicle, having a drive arrangement which is supported on the carrying element and which drives the ball, and having a controller, via which the drive arrangement can be controlled in a desired direction of travel in dependence upon the inclination of the carrying element and the direction of inclination of the carrying element, is provided in that the drive arrangement comprises four omni-wheels, of which at least two omni-wheels have an angle of tilt not equal to zero. In conjunction with the present invention, an angle of tilt is understood to mean that an omni-wheel standing or lying tangentially against the surface is tilted to the right or left by an angle of tilt with respect to a notional rolling direction of the ball. Therefore, in addition to its driving force in the rolling direction of the ball, the omni-wheel can therefore also apply a lateral driving component to the ball, which can be used for a rotation of the carrying element about a vertical axis of the ball in the right and left directions and can be used for stabilisation in the direction of rotation about the vertical axis. For this purpose, at least two of the omni-wheels are tilted in a co-rotating manner in order to be able to achieve both directions of rotation of the carrying element about the vertical axis of the ball independently of the respective rolling direction of the ball. It follows directly from this that, in a co-rotating manner, starting from a reference axis, which is vertical as seen when the carrying element is horizontal, is to be equated with a positive or a negative angle of tilt. A single omni-wheel is considered in the direction of the center of the ball in each case. The angle of tilt could thus also be referred to as the steering angle. The four omni-wheels together with the angle of tilt in accordance with the invention thus make it possible, via the drive arrangement, for the vehicle to be able to be moved by a rider, who stands in a freely balancing manner on the carrying element, in any directions of travel without the use of a holding bar, with or without a steering bar, and to be able to rotate about its own vertical axis. In this context, “to be able to be moved in any directions of travel” is to be understood to mean that the direction of travel, for example a forwards travel direction of the vehicle, is decoupled from the direction in which the rider is looking or facing, i.e. the rider can also travel in a forwards travel direction obliquely with respect to the direction in which he is facing.

The vehicle is controlled exclusively via the feet of the rider freely balancing on the carrying element. By shifting his weight, the rider initiates the movement of the vehicle. The controller thus reacts to the change in an angle of inclination of the carrying element and, via the drive arrangement, drives the ball to roll in the desired direction. Therefore, the controller compensates for the measured inclination of the carrying element so that it is located in a preferably horizontal orientation. The rider preferably simply stands on the carrying element in the region of the stand-on surfaces which are provided with anti-slip overlays so that the rider can stand firmly and safely and for better coordination of the shifting of weight.

In a particular embodiment provision is made for the angle of tilt relative to the vertical axis of the ball to be between −45 and +45 degrees (excluding 0 degrees, preferably excluding 2 to −2 degrees) and preferably in the range of −5 to −15 and +5 to +15 degrees (excluding 0 degrees, preferably excluding 2 to −2 degrees). In this way, a good level of rotatability of the ball about the vertical axis at the same time as good application of the driving forces to the surface of the ball for all travel movements is achieved. Following the feature of co-directionality, the angles of tilt of the at least two omni-wheels also have the same sign.

In a particular embodiment, provision is made for the angles of tilt of two opposing omni-wheels to be co-rotating. In this way, a good transmission of the driving forces for the rotation about the vertical axis is achieved.

Reliable rotatability of the ball about the vertical axis is achieved when all the omni-wheels are tilted by an angle of tilt and the angles of tilt of the opposing omni-wheels are co-rotating and the angles of tilt of the adjacent omni-wheels are counter-rotating.

The omni-wheels which are located on the opposite sides relative to a line extending via the center point of the ball as seen in a plan view of the ball are considered to be opposing.

Furthermore, provision is alternatively made for all omni-wheels to be tilted by an angle of tilt, and the angles of tilt of both adjacent and also opposing omni-wheels are co-rotating.

In an advantageous manner, the vehicle is designed in such a way that the omni-wheels are folded by a fold angle relative to the longitudinal axis of the ball, wherein the fold angle is between −110 and +110 degrees, preferably between 0 and 45 degrees. In this way, a particularly compact construction for the vehicle is achieved.

An optimal arrangement of the omni-wheels relative to the vertical axis of the ball is achieved by a spacing angle between the omni-wheels being between 80 and 110 degrees, preferably being 90 degrees. In this way, the driving forces can be introduced into the ball in a particularly satisfactory manner. In this context and with the spacing angle of 90 degrees, it is particularly advantageous if the forwards travel direction of the vehicle between two omni-wheels is 45 degrees and cuts the center of the ball in a conventional manner.

Furthermore, provision is made for an angle of elevation between a line, which extends from the center point of the ball through an axis of rotation of the respective omni-wheels, and the equator of the ball between −20 and +65 degrees, preferably between 0 and 45 degrees, particularly preferred 0 degrees. The adjustment of the angle of elevation influences the travel and inclination behaviour of the vehicle. The greater the angle of elevation, the greater the angle of inclination of the carrying element. With the larger angle of inclination of the carrying element, it is possible to change the direction of travel and the speed more quickly.

In conjunction with the angles of tilt, fold angles and angles of elevation described above and the indicated ranges relating thereto, reference is made to the fact that although, in relation to the angles of tilt, fold angles and angles of elevation, these each preferably comprise absolutely the same numerical value, they can also be entirely different from each other.

In a particular embodiment, provision is made for the carrying element to reproduce the shape of the ball with a larger diameter. The spherical design of the carrying element makes possible a compact construction.

In an advantageous manner, the carrying element is designed in such a way that it comprises a cover part, two stand-on parts and a ring part, the cover part covers the upper part of the ball, and the lower part of the ball protrudes downwards out of the ring part. The cover part covers the upper part of the ball and therefore protects the rider from contact with the rotating ball during travel. The stand-on parts offer the rider a sufficient standing surface which, with a slightly raised edge, ensures safe standing.

The ring part serves to stabilise the stand-on surface and also protects the components of the drive arrangement from dirt and protects the feet of the rider from possible contact with the rotating omni-wheels.

Constructionally, it is particularly advantageous that the stand-on parts of the carrying element are disposed substantially at an equator of the ball. In this way, an average balance capability of the vehicle in relation to the difficulty is achieved.

For good balance capability of the vehicle by the position of the ball between the feet of the rider and quicker starting by the adoption of the predetermined positions of the feet, provision is made for stand-on surfaces for the rider to be disposed on the stand-on parts and for the stand-on parts with stand-on surfaces to be disposed in an opposing manner in relation to the ball.

In a particular manner provision is made for the drive arrangement to be attached to the ring part of the carrying element and for the four omni-wheels each to be mounted on an axis of rotation for transmission of the driving forces to the ball.

It is also advantageous to the weight of the vehicle that each omni-wheel is driven by an electric motor directly and without interconnection of a transmission and that each electric motor is attached to the ring part of the carrying element.

In a preferred embodiment provision is made for the electric motors to be powered via at least one rechargeable battery and for the batteries to be disposed in the installation space of the carrying element in a uniformly distributed manner around the circumference of the ball. The arrangement of the batteries around the circumference of the ball is not an impairment to the travel behaviour of the vehicle owing to a uniform weight distribution.

In order to determine the position of the carrying element in space, gyroscopes are disposed on the carrying element, with which the degree of inclination and direction of inclination of the carrying element can be measured and the measured inclination and direction of inclination are transmitted to the evaluating controller.

In an advantageous embodiment provision is made for the controller to comprise a balance control module which assists a rider in balancing the carrying element into a horizontal position in space. This balancing of the carrying element in a balanced orientation is effected via corresponding actuation of the first to the fourth omni-wheels. The degree of assistance can be varied and be set at such a high level that it is relatively easy for the rider to balance on the carrying element. On the other hand, the level of assistance is not so great that the rider is prevented from effecting an acceleration of the vehicle in the direction of inclination by reason of a weight-shift by shifting his weight in the manner of an accelerator pedal.

Constructionally, it is advantageous in a particular embodiment to provide four sensors that are disposed on the stand-on surfaces of the carrying element, these sensors register the presence of the toes or of the heels of the rider's feet and transmit the measured change in weight to the evaluation controller. The raising and lowering of the rider's toes and heels makes it possible to control the rotation of the vehicle about the vertical axis.

Optimal travel behaviour of the vehicle without sudden or abrupt movements is achieved in that the carrying element is supported on the ball via a support arrangement, wherein the support arrangement comprises at least one non-driven omni-wheel.

In a preferred embodiment provision is made for the vehicle to have no handle in relation to the rider. Therefore, the rider can balance freely on the carrying element of the vehicle in the manner of riding a skateboard without supporting himself with his hands on a column or on a steering bar or sitting on a saddle or seat disposed on the carrying element.

The invention is explained in more detail hereinunder with the aid of an exemplified embodiment illustrated in the drawings.

### BRIEF DESCRIPTION OF THE DRAWINGS

FIG. 1 shows a perspective view showing the principle of a vehicle in accordance with the invention for the locomotion of a rider, in a first embodiment;

FIG. 2 shows a plan view of the vehicle of FIG. 1 without a rider;

FIG. 3 shows a side view of the vehicle of FIG. 2;

FIG. 4 shows a further side view of the vehicle of FIG. 2;

FIG. 5 shows a horizontal cross-sectional view through the vehicle of FIG. 2;

FIG. 6 shows a schematic view of the ball with a single omni-wheel;

FIG. 7 shows a vertical cross-sectional view through the vehicle of FIG. 2;

FIG. 8 shows a further schematic view of the ball with a single omni-wheel;

FIG. 9 shows a further schematic view of the ball with a single omni-wheel;

FIG. 10 shows a further vertical cross-sectional view through the vehicle of FIG. 2;

FIG. 11 shows a schematic plan view of a ball with driving omni-wheels;

FIG. 12 shows a schematic side view of the ball with omni-wheels and a support arrangement;

FIG. 13 shows a further schematic side view of the ball with omni-wheels;

FIG. 14 shows a further schematic plan view of the ball with omni-wheels and the support arrangement;

FIG. 15 shows a simplified diagram of the controller of the vehicle;

FIG. 16 shows a schematic plan view of the ball with omni-wheels and sensors on the stand-on surfaces; and

FIG. 17 shows a perspective view of the vehicle of FIG. 1 with foot positioning during the starting procedure.

### DESCRIPTION OF PREFERRED EMBODIMENTS

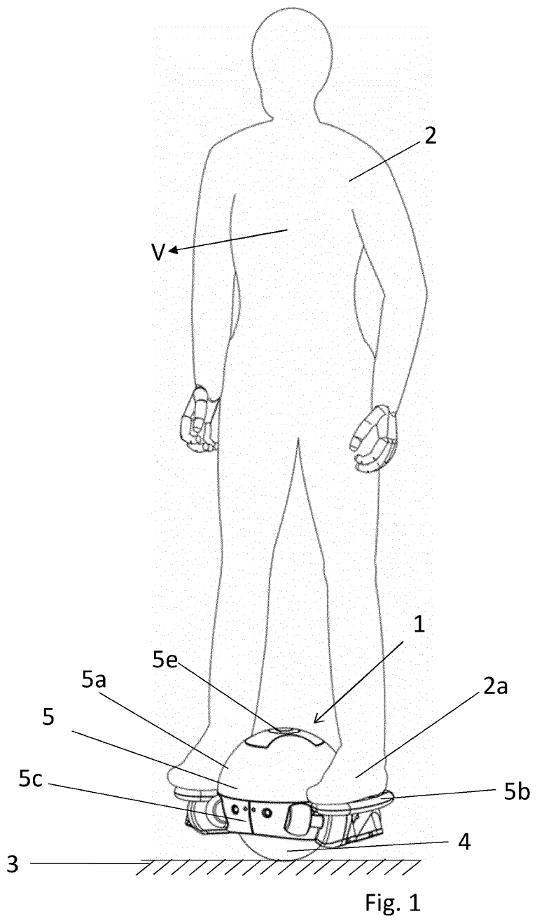

FIG. 1 illustrates a perspective view showing the principle of a vehicle 1 in accordance with the invention, in particular of a skateboard-like ball roller, for the locomotion of a rider 2. The vehicle 1 essentially consists of a ball 4 rolling on a ground surface 3, a carrying element 5 supported on the ball 4, and a drive arrangement 6, not shown in this figure, with a controller 7. The use of the ball 4 as wheel replacement has the advantage that the vehicle 1 can be moved on the ground surface 3 in any desired directions. The ball 4 has a diameter in the range of 100 mm to 500 mm, preferably in the range of 200 mm to 250 mm. The vehicle 1 can also be referred to as a sports device, leisure device or fun device, on which the rider 2 stands during use in a freely balancing manner on the carrying element 5 as on a skateboard and in which the rider 2 controls, brakes and steers the vehicle 1 by shifting his weight. Furthermore, the vehicle 1 has no handle in relation to the rider 2. Therefore, the rider 2 has no assistance means available to him, such as a steering bar, a column for support or a seat for sitting on, or as an aid to balancing. Therefore, the rider 2 must balance freely on the carrying element 5 of the vehicle 1 without supporting himself with his hands on a column or on a steering bar or with his shins on a knee board or sitting on a saddle or seat disposed on the carrying element 5.

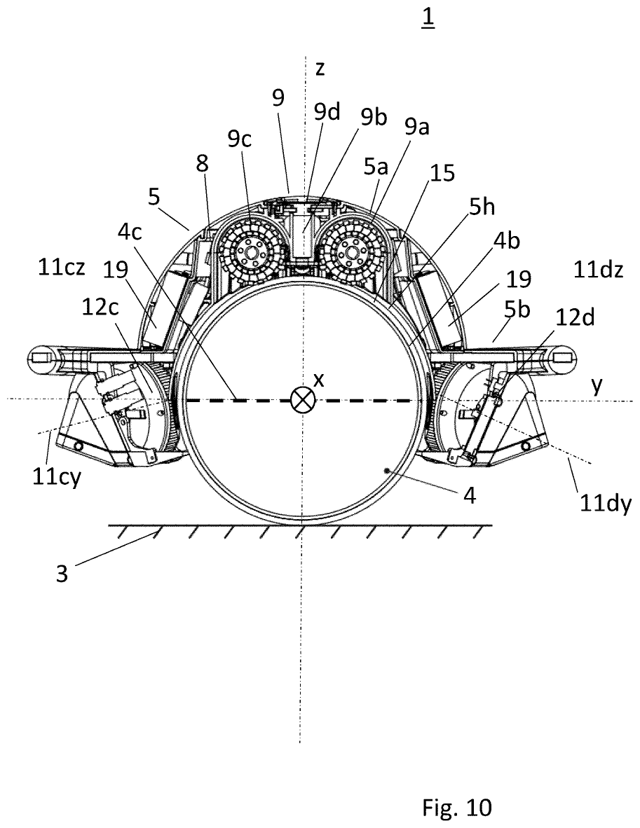

The carrying element 5 is a complex component with a plurality of functions and for this purpose comprises a cover part 5a, two stand-on parts 5b and a ring part 5c. An upper part 4a of the ball 4 is covered by the cover part 5a which therefore protects the rider 2 from contact with the rotating ball 4, and the cover part 5a surrounds an installation space 8 (see FIG. 10) between a surface 4b of the ball and an inner side 5h of the cover part 5a. The cover part 5a is also centrally supported on the ball 4 via a support arrangement 9 which in FIG. 1 is concealed by the cover part 5a.

Stand-on parts 5b disposed in an opposing manner with respect to the ball 4 adjoin a lower edge of the cover part 5a. The two stand-on parts 5b protrude outwards as lateral projections away from the cover part 5a and form stand-on surfaces 10, which are substantially planar or horizontal as seen when the vehicle 1 is a horizontal balance position, for a right and left foot 2a of the rider 2. As seen with the vehicle 1 in a forwards travel direction V, the stand-on surfaces 10 are disposed on the right and left next to the ball 4. The forwards travel direction V relates to the rider 2 who moves looking straight ahead, i.e. facing forwards. Both stand-on parts 5b are formed as a trapezoid with rounded corners as seen in plan view. Furthermore, the stand-on parts 5b are formed as a plate or metal sheet so that the height of the horizontally orientated stand-on part 5b corresponds to only a fraction of the height of the ball 4.

For the rider 2, the vehicle 1 provides two stand-on surfaces 10 for the feet 2a of the rider 2 on the stand-on parts 5b. These stand-on surfaces 10 can be mere markings in the size of feet 2a or can be free regions on the stand-on parts 5b with an anti-slip coating or fitted with a slip-reducing layer. The stand-on parts 5b are formed in such a way that the outer edges 5b thereof are somewhat higher than the stand-on surfaces 10. In this way, a clear boundary of the stand-on surfaces 10 is ensured so that the rider 2 can stand safely on the stand-on parts 5b so that slipping from the stand-on surfaces 10 can be avoided. To facilitate mounting onto the vehicle 1 and dismounting from the vehicle 1, no further attachment means for the feet 2a on the stand-on parts 5b are provided.

However, the stand-on surfaces 10 can also alternatively be formed as free surfaces without an outer edge 5d with a holding strap or in a shoe-like or sandal-like manner with or without holding straps or means acting in the same way, in order to provide the rider 2 with a more secure hold on the stand-on parts 5b during travel. The stand-on surfaces 10 indirectly also determine the size or width of the stand-on parts 5b since the rider 2 must stand comfortably and safely on the stand-on parts 5b in order to be able to control the vehicle 1 by shifts in weight. It is fundamentally also feasible for the stand-on parts 5b to be not only trapezoidal but also oval, rectangular or polygonal or of a combined geometric shape. However, the trapezoidal stand-on parts 5b have the advantage that the rider 2 has sufficient stability in spite of a material-saving design and enjoys faster start-up by adopting a predetermined rider position.

A circumferential ring part 5c adjoins a lower edge of the cover part 5a or the two stand-on parts 5b underneath, said ring part serving to stabilise the stand-on parts 5b and as a cover for components of the drive arrangement 6, such as, for example, omni-wheels 11a, 11b, 11c, 11d and motors 12a, 12b, 12c, 12d. Therefore, the ball 4 generally protrudes with a part of its lower part downwards out of the carrying element 5 or the ring part thereof 5c. The ring part 5c protects the drive arrangement 6 against dirt and protects the feet 2a of the rider against possible contact with the rotating omni-wheels 11a, 11b, 11c, 11d and the motors 12a, 12b, 12c, 12d.

In the embodiments described above, the carrying element 5 comprises a ring part 5c as an extension of the cover part 5a in the downwards direction and for support of the stand-on parts 5b. Alternatively, this carrying element 5 can be reduced to a part which, as seen in the forwards travel direction V, resembles a trapezoidal roof profile in cross-section. Starting from the top, this carrying element 5 therefore consists of a flat horizontal crossbar, which is adjoined by a downwardly extending lateral web at the edges on the right and left and therefore laterally next to the ball 4 in each case. The crossbar is therefore located above the ball 4 and the two lateral webs extend, starting from the crossbar, perpendicularly or obliquely outwards, spreading downwards to approximately at the equator 4c of the ball 4. The horizontal outwardly pointing stand-on parts 5b adjoin the lower ends of the lateral webs.

FIG. 1 also shows that the vehicle 1 has no handle in relation to the rider 2. However, in an alternative embodiment, the vehicle 1 can be provided at the top with a central opening 5e in the cover part 5a of the carrying element 5 for a handle, a holding bar, with or without a steering bar, or a seat, which can each be added simply as required in order to offer more safety in balancing on the vehicle 1.

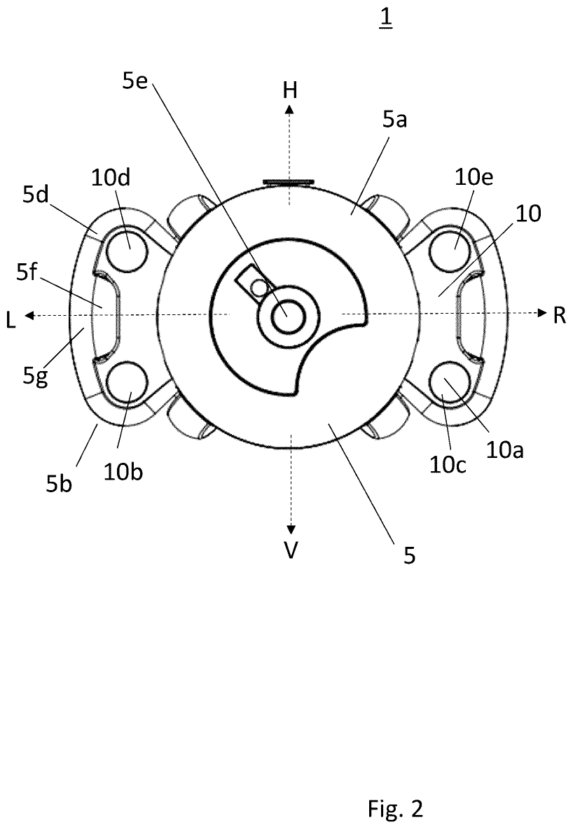

FIG. 2 shows a plan view of the vehicle 1 without a rider 2. This view shows the design of the stand-on parts 5b of the carrying element 5 particularly well. The trapezoidal or triangular stand-on parts 5b are disposed in an opposing manner in relation to the ball 4 at a transition between the cover part 5a and the ring part 5c. Each of the stand-on parts 5b comprises a stand-on surface 10, an outer edge 5b, a handle opening 5f and a handle 5g. The cylindrical outer edge 5d, which is higher than the stand-on surface 10, defines the trapezoidal stand-on part 5b on the outside and therefore creates a clear boundary of the stand-on surface 10. The height difference between the stand-on surface 10 and the outer edge 5d is a fraction of the total height of the stand-on parts 5b. In this way, the boundary of the stand-on surfaces 10 is ensured in the shape, that means the rider 2 cannot slip off the stand-on surface 10 during travel but at the same time also cannot stumble over it during mounting and dismounting. Alternatively, the outer edge 5d can also be of a different shape which is rounded in any way or angular or polygonal. However, the advantage of a cylindrical outer edge 5d is that the feet 2a of the rider 2 come up against little or even no resistance during a sliding dismount.

The stand-on surfaces 10 are each provided with two anti-slip overlays 10a. The anti-slip overlays 10a are each located in the front region of the foot 2a, specifically in the region of the toes, and in the rear region of the foot 2a, specifically in the region of the heel. In this way, firm standing for the rider 2 on the stand-on surfaces 10 of the carrying element 5 is ensured and better coordination of the weight shifting is rendered possible. The anti-slip overlays 10a attached to the stand-on surfaces 10 offer, in conjunction with the outer edge 5d, which is higher than the stand-on surfaces 10, a predetermined safe position for the feet 2a of the rider 2. Under each anti-slip overlay 10a are a total of four sensors 10b, 10c, 10d, 10e which register the raising of the toes or of the heel by the subsequent weight change and send a corresponding signal to the controller 7. In this way, the movement of the vehicle 1 is initiated and the desired direction of movement is determined.

The stand-on parts 5b each have a handle opening 5f and a handle 5g formed thereby. The handle opening 5f with rounded corners and edges is located on the outer side of the stand-on part 5b in relation to the ball 4, adjacent the outer edge 5d. The handle opening 5f is formed in such a way that a hand of the rider 2 can pass through. Alternatively, the corners and edges of the handle opening 5f remain non-rounded. However, the rounded corners and edges ensure that the risk of injury when reaching through the handle opening 5f is considerably less than in the case of non-rounded corners and edges. The outer edge 5d of the stand-on part 5b which is freed up by the handle opening 5f forms a handle 5g for easy carrying of the vehicle 1 between journeys. A carrying strap or similar aid can also be attached to one handle 5g of the stand-on part 5b or to both at the same time.

In order to be able to explain the directions of travel and operation of the vehicle 1 in more detail hereinunder, a Cartesian coordinate system is placed with its origin in the center point of the ball 4. The longitudinal axis x of this coordinate system therefore points in the forwards travel direction V and backwards travel direction H, the transverse axis y points in the right travel direction R and left travel direction L and the vertical axis z points vertically. The longitudinal axis x and the transverse axis y extend in parallel and the vertical axis z is at a right angle to a horizontal ground surface 3.

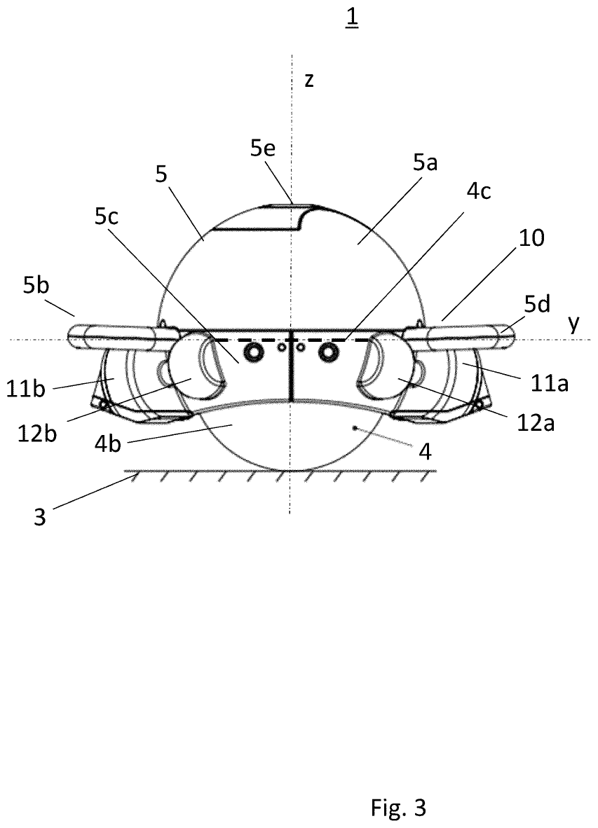

FIG. 3 shows a side view of the vehicle 1 in accordance with the invention of FIG. 2 in the x direction or in the backwards travel direction H. The figure shows that the stand-on parts 5b of the carrying element 5 are disposed in their horizontal position preferably at an equator 4c in relation to a vertical axis z of the ball 4. It is also feasible for the stand-on parts 5b to be disposed higher for advanced riders or lower for beginners. In this way, greater or smaller angles of inclination of the stand-on parts 5b in relation to the ball 4 are made possible, which make balancing, mounting or dismounting or controlling of the vehicle 1 more difficult or easier.

FIG. 3 also shows that the cover part 5a of the carrying element 5 is spherical and therefore reproduces the shape of the ball 4 but with a larger diameter. The advantage of this spherical design resides in a greater inclining capability of the carrying element 5 via a support arrangement 9 (see FIG. 10) in relation to the ball 4. However, alternatively other geometric designs are also feasible which, as required, limit the angle of inclination of the carrying element 5 by transitions from a spherical to an angular shape.

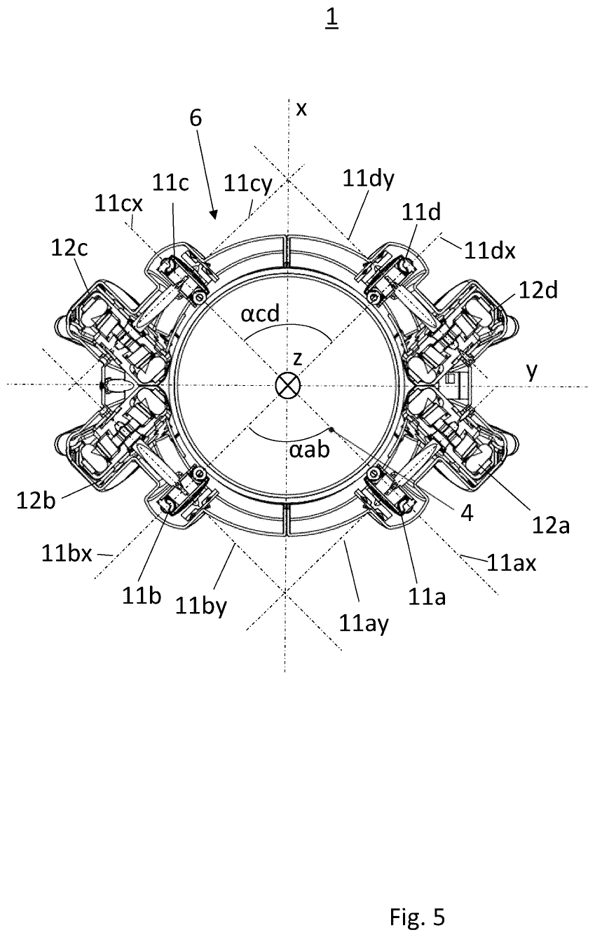

The contours of a first and a second motor 12a and 12b and the omni-wheels 11a and 11b driven thereby can be seen in spite of the covering ring part 5c. A third and a fourth omni-wheel 11c, 11d and the associated motors 12c, 12d (see FIG. 5) are concealed by the ball 4 and the ring part 5c.

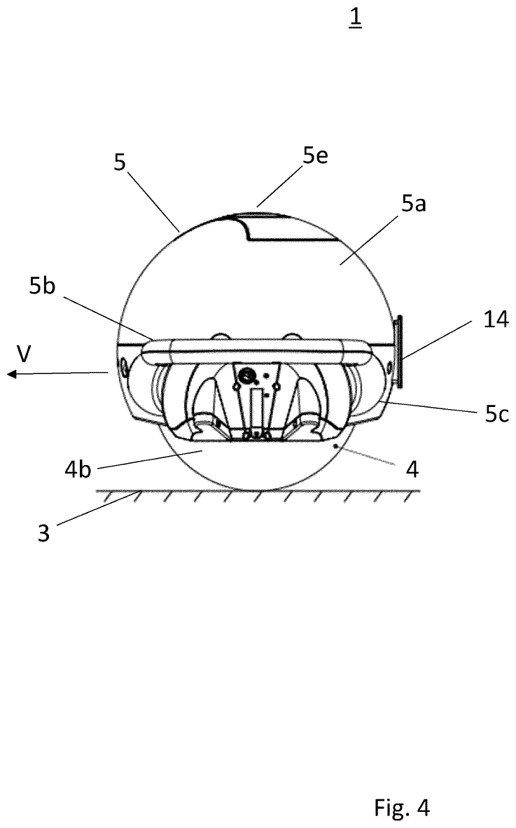

FIG. 4 shows a further side view of the vehicle 1 of FIG. 2. One of the two stand-on parts 5b is shown in the foreground. On the side of the vehicle 1 opposite to the forwards travel direction V, in its carrying element 5 in a transition region of the cover part 5a and ring part 5c, a charging socket 14 for recharging the batteries 19 (see FIG. 10) of the vehicle 1 is disposed.

FIG. 5 shows a horizontal cross-sectional view through the vehicle 1 at the equator 4c of the ball 4. This view shows the design of the drive arrangement 6 in the carrying element 5 particularly well. The drive arrangement 6 essentially consists of a first omni-wheel 11a, a second omni-wheel 11b, a third omni-wheel 11c and a fourth omni-wheel 11d which are each driven directly and without interconnection of a transmission by a first motor 12a, a second motor 12b, a third motor 12c and a fourth motor 12d. The omni-wheels 11a, 11b, 11c, 11d each preferably have the same diameter in the range of 20 mm to 300 mm, preferably in the range of 50 mm to 70 mm. In order to be able to describe the orientation of the omni-wheels 11a, 11b, 11c, 11d with respect to the ball 4 in each case, for each of the omni-wheels 11a, 11b, 11c, 11d there is provided a dedicated Cartesian coordinate system with an origin in the center of the omni-wheel 11a, 11b, 11c, 11d and therefore also in the center of its respective axis of rotation 11ay, 11by, 11cy, 11dy. This coordinate system comprises as a transverse axis y the respective axis of rotation 11ay, 11by, 11cy, 11dy, a longitudinal axis x 11ax, 11bx, 11cx, 11dx, which extends through a center of a running surface of the respective omni-wheel 11a, 11b, 11c, 11d, and a vertical axis z 11az, 11bz, 11cz, 11dz which extends through the center of the running surface of the respective omni-wheel 11a, 11b, 11c, 11d. The omni-wheels 11a, 11b, 11c, 11d are rotatably mounted on and about the first axis of rotation 11ay, the second axis of rotation 11by, the third axis of rotation 11cy and the fourth axis of rotation 11dy respectively.

The omni-wheels 11a, 11b, 11c and 11d used are generally known and are also referred to as omni-directional wheels. The running surface of the omni-wheels 11a, 11b, 11c and 11d consists of a plurality of rollers disposed around the circumference, the axes of rotation of which are substantially orthogonal to the axis of rotation 11ay, 11by, 11cy and 11dy of the respective omni-wheel 11a, 11b, 11c and 11d and tangential to a circumference or a running surface of the omni-wheel 11a, 11b, 11c and 11d. The use of omni-wheels 11a, 11b, 11c and 11d makes it possible for the ball 4 to be able to rotate with low friction in not only the driving direction of the respective omni-wheel 11a, 11b, 11c and 11d but in all other directions of the respective omni-wheel 11a, 11b, 11c and 11d.

By means of the omni-wheels 11a, 11b, 11c and 11d the vehicle 1 can travel in all directions V, H, R and L and intermediate directions thereof and rotate about the vertical axis z of the ball 4. The axes of rotation 11ay, 11by, 11cy, 11dy are disposed spaced apart from and tangential to the surface 4b of the ball 4. In the case of a horizontal ground surface 3 and a stand-on surface 10 of the carrying element 5 parallel thereto, the axes of rotation 11ay, 11by, 11cy, 11dy are orientated rising towards or falling away from the ground surface 3. Furthermore, the omni-wheels 11a, 11b, 11c, 11d are distributed substantially uniformly around the circumference of the ball 4 relative to the vertical axis z of the ball 4.

As seen in relation to the origin of the coordinate system of the ball 4 and to the x-y plane, the longitudinal axes 11ax and 11bx and 11cx and 11dx of omni-wheels 11a and 11b and 11c and 11d are disposed spaced apart from each other by a spacing angle αab and αcd respectively. In this embodiment, the spacing angles αab and αcd are equal. However, provision can be made for each spacing angle αab, αcd to be individually adjustable. The spacing angles αab, αcd are in a range of 80 degrees to 110 degrees and are preferably equal to 90 degrees. In this embodiment, the axis of rotation 11by of the second omni-wheel 11b is orientated orthogonal to the axis of rotation 11cy of the third omni-wheel 11c and the axis of rotation 11ay of the first omni-wheel 11a is orthogonal to the axis of rotation 11dy of the fourth omni-wheel 11d. Therefore, the axes of rotation 11ay and 11cy of the omni-wheels 11a and 11c are parallel to one another.

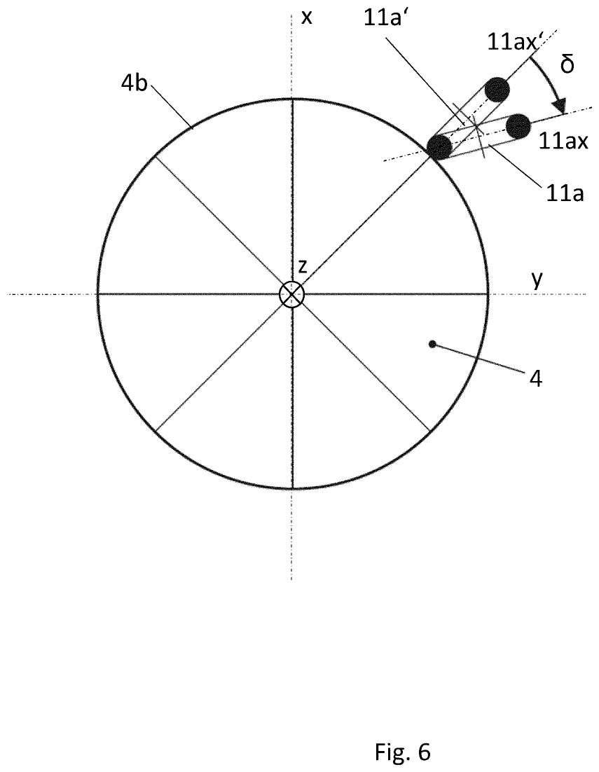

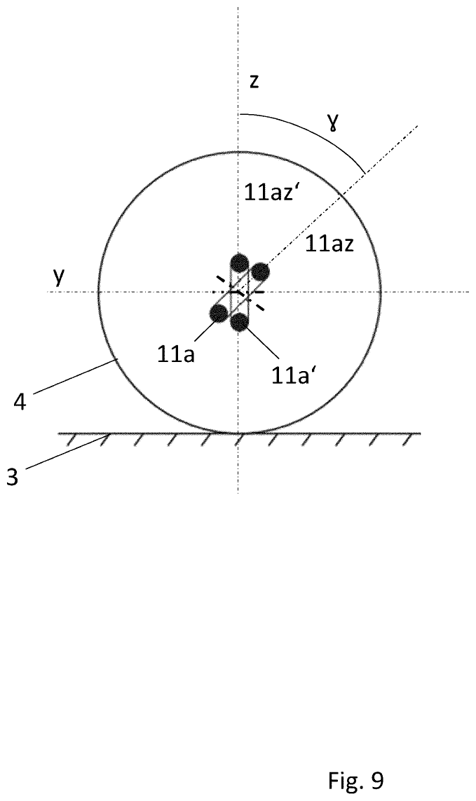

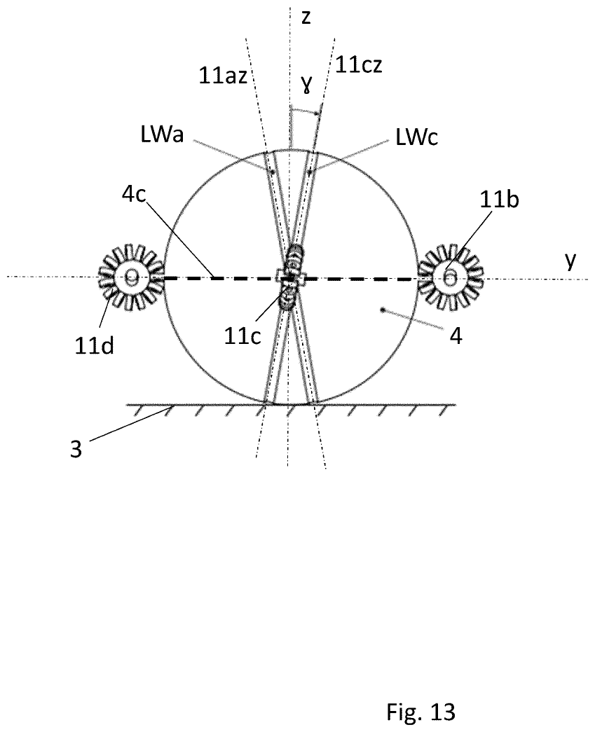

The omni-wheels 11a, 11b, 11c, 11d are positioned with their longitudinal axes 11ax, 11bx, 11cx and 11dx orthogonal to the surface 4b of the ball 4 or to a tangent to the surface 4b of the ball 4 and to a contact surface of the respective omni-wheel 11a, 11b, 11c, 11d with the surface 4b of the ball 4. The omni-wheel 11a, 11b, 11c, 11d therefore has neither an angle of tilt (see FIG. 9) nor a fold angle. A fold angle δ explained with reference to the following FIG. 6 is therefore 0 degrees for all the omni-wheels 11a, 11b, 11c, 11d. In this embodiment, the fold angles δ of all omni-wheels 11a, 11b, 11c and 11d are equal. However, provision can be made for each fold angle δ to be individually adjustable. The orientation or the inclination of the omni-wheels 11a, 11b, 11c, 11d relative to the axis y of the ball 4 has an effect on the transmission of the turning moment and can therefore influence the speed of reaction of the vehicle 1. Coordinated operation of the omni-wheels 11a, 11b, 11c and 11d therefore leads to a movement of the vehicle 1 in the forwards travel direction V and right travel direction R or in the backwards travel direction H and left travel direction L or in any intermediate direction thereof. A movement of the vehicle 1 in the forwards travel direction V or backwards travel direction H is achieved, for example, in that the first and the second omni-wheels 11a and 11b are driven in one direction and the two other omni-wheels 11c, 11d are driven in a counter-rotating manner. A rotation about the vertical axis z of the ball 4 is made possible in that the omni-wheels 11a, 11b, 11c and 11d are tilted as defined by the angle of tilt γ (see FIG. 13).

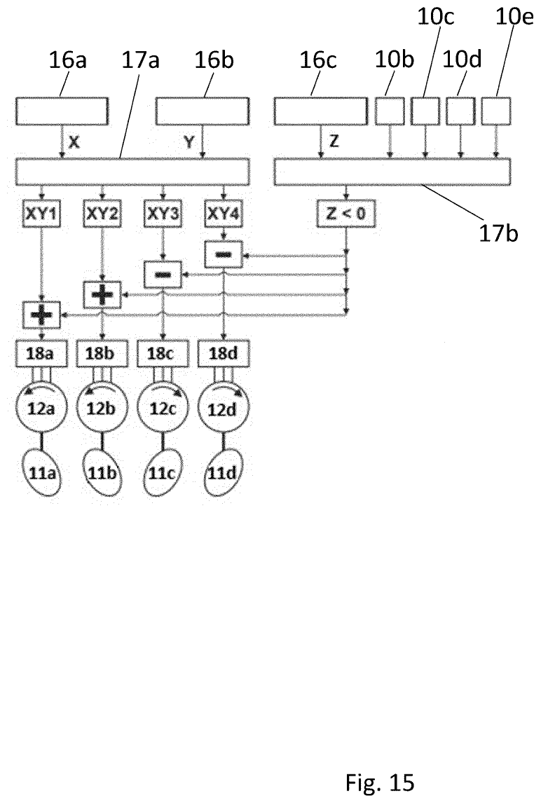

The motors 12a, 12b, 12c and 12d are attached to the ring part 5c of the carrying element 5 and are actuated via a controller 7 (see FIG. 15). 24V direct current motors are used as motors 12a, 12b, 12c and 12d, having power levels in the range of 350 Watt to 800 Watt.

FIG. 6 shows a schematic view of the ball 4 with a single omni-wheel 11a in order to indicate the fold angle δ. By means of a fold angle δ, on the one hand, a rotation of the vehicle 1 about the vertical axis z by means of the driven motors 12a, 12b, 12c, 12d can be achieved and, on the other hand, in the case of omni-wheels 11a, 11b, 11c, 11d with a larger diameter, installation space can be saved by placing the omni-wheels 11a, 11b, 11c, 11d against the surface 4b of the ball 4. FIG. 6 clearly shows that the fold angle δ is formed between the x axis 11ax, 11bx, 11cx, 11dx of the respective inclined omni-wheel 11a, 11b, 11c, 11d and the x axis 11ax′, 11bx′, 11cx′, 11dx′ of a non-inclined omni-wheel 11a′, 11b′, 11c′, 11c′, 11d′. The fold angle δ is in the range of −110 to +110 degrees and is preferably 0 degrees or 45 degrees.

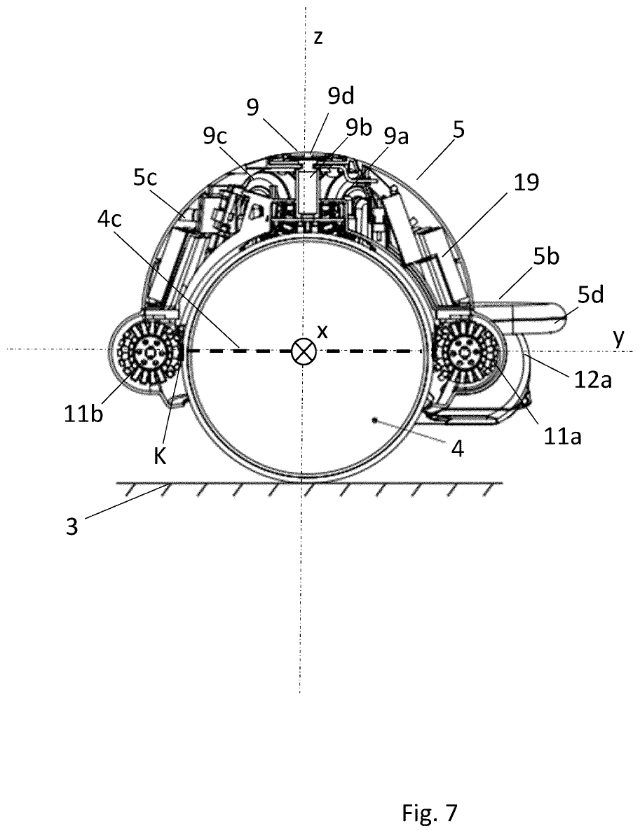

FIG. 7 shows a vertical cross-sectional view through the vehicle 1 of FIG. 2 through the center of the ball 4. The omni-wheels 11a, 11b and the support arrangement 9 located in the installation space 8 and comprising four omni-wheels 9a, 9b, 9c, 9d, and batteries 19 can be clearly seen. FIG. 7 also shows that, between the surface 4b of the ball 4 and the inner side 5h of the cover part 5a, a circumferential gap 15 remains which permits free rotatability of the ball 4 relative to the carrying element 5. The vehicle 1 can also be provided with suspension in the region of the steering of the omni-wheels 11a, 11b, 11c, 11d or via an elastic ball. The ball 4 is produced from hard plastics material. Bowling balls, for example, are suitable. Furthermore, it can be seen that the omni-wheels 11a, 11b engage in the region of the equator 4c.

By tilting the omni-wheels 11a, 11b, 11c, 11d relative to the vertical axis z of the ball 4 by an angle of tilt γa, γb, γc, γd, a rotation of the vehicle 1 about the z axis of the ball 4 by a rotation of the carrying element 5 controlled by the rider 2 is possible and so the rider 2 remains orientated facing forwards in the respective direction of travel. In this way, the vehicle 1 can also be stabilised in relation to an undesired rotation of the carrying element 5 about the ball 4. This may be necessary, for example, during movements of the vehicle 1 in the forwards travel direction V or in the backwards travel direction H. The angle of tilt γa, γb, γc, γd cannot be seen in this figure and is explained hereinunder with reference to FIG. 9. Since the omni-wheels 11a, 11b, 11c, 11d are placed against the surface 4b of the ball 4 in order to transmit the turning moment, in this way a contact surface K is formed between the running surface of the omni-wheels 11a, 11b, 11c, 11d and the surface 4b of the ball.

The batteries 9 are disposed in the installation space 8 above the stand-on parts 5b between the carrying element 5 and the surface 4b of the ball 4. The batteries 19 are distributed substantially uniformly over the circumference of the ball 4 about the vertical axis z of the ball 4.

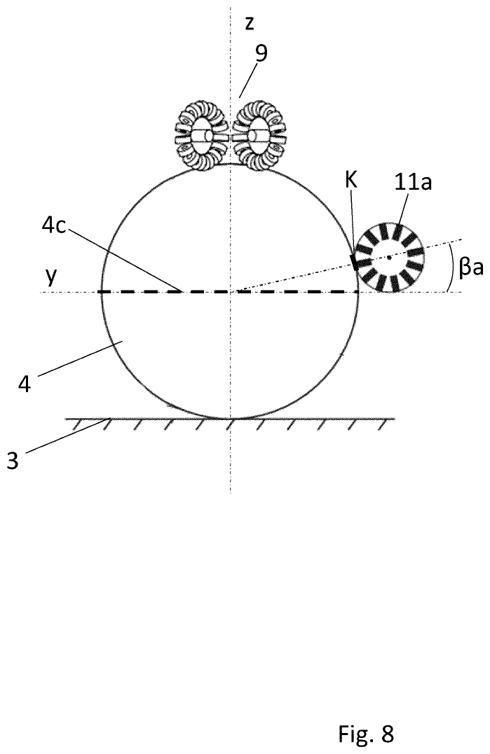

FIG. 8 shows a further schematic view of the ball 4 with a single omni-wheel 11a and the support arrangement 9 in order to indicate the angle of elevation β. By means of an angle of elevation β the travel behaviour and inclination behaviour of the vehicle 1 can be influenced. FIG. 8 clearly shows that the angle of elevation β is formed between the equator 4c and a line extending between the center point of the ball 4 and the respective axis of rotation 11ay, 11by, 11cy, 11dy of the omni-wheels 11a, 11b, 11c and 11d. The angle of elevation β is in the range of −20 to +65 degrees and is preferably 0 degrees or 45 degrees.

FIG. 9 is a further schematic view of the ball 4 with a single omni-wheel 11a to indicate the angle of tilt γ. By means angle of tilt γ of at least two omni-wheels 11a, 11b, 11c, 11d, a rotation of the vehicle 1 about the vertical axis z in the right and left directions and also stabilisation in the direction of rotation about the z axis can be achieved. FIG. 9 clearly shows that the angle of tilt γ is formed between the vertical axis 11az, 11bz, 11cz, 11dz of the respective inclined omni-wheel 11a, 11b, 11c, 11d and the vertical axis 11az′, 11bz′, 11cz′, 11dz′ of a non-inclined omni-wheel 11a′, 11b′, 11c′, 11d′. The vertical axis 11az′, 11bz′, 11cz′, 11dz′ corresponds to the vertical axis z of the ball 4 when the carrying element 5 is orientated horizontally. The angle of tilt γ is in the range of −45 to +45 degrees (excluding 0 degrees, preferably excluding 2 to −2 degrees), preferably in the range of −5 to −15 and +5 to +15 degrees and particularly preferably +10 degrees or −10 degrees. The angles of tilt γ of the respective omni-wheels 11a, 11b, 11c, 11d are equal in terms of amount. Alternatively, only the angles of tilt γ of the respective two opposing omni-wheels 11a, 11b, 11c, 11d are equal in terms of amount.

Furthermore, FIG. 10 shows a further vertical cross-sectional view through the vehicle 1 of FIG. 2, clearly showing the construction and disposing of a support arrangement 9 for the ball 4. The whole carrying element 5 is supported at the top on the ball 4 in the region of the center of the cover part 5a via the support arrangement 9 and laterally via the omni-wheels 11a, 11b, 11c, 11d. In the illustrated embodiment, the support arrangement 9 comprises four non-driven omni-wheels 9a, 9b, 9c, 9d which can each rotate about its own axis of rotation and which are disposed, as seen in relation to the origin of the coordinate system of the ball 4 and to the z-y plane, at the highest point of the surface 4b of the ball 4 and are distributed uniformly about the axis z very close to, but not touching, each other. The axes of rotation of the omni-wheels 9a, 9b, 9c, 9d of the support arrangement 9 are substantially parallel to the stand-on surfaces 10 or to the ground surface 3 when the ground surface 3 is horizontal. Alternatively, an embodiment with an omni-wheel or another type of ball mounting is also possible. However, the advantage of the support arrangement 9 with four omni-wheels 9a, 9b, 9c, 9d is that the rolling of the ball 4 feels softer for the rider 2 and, by the avoidance of possible sudden or abrupt movements, wear on the four omni-wheels 9a, 9b, 9c, 9d is reduced.

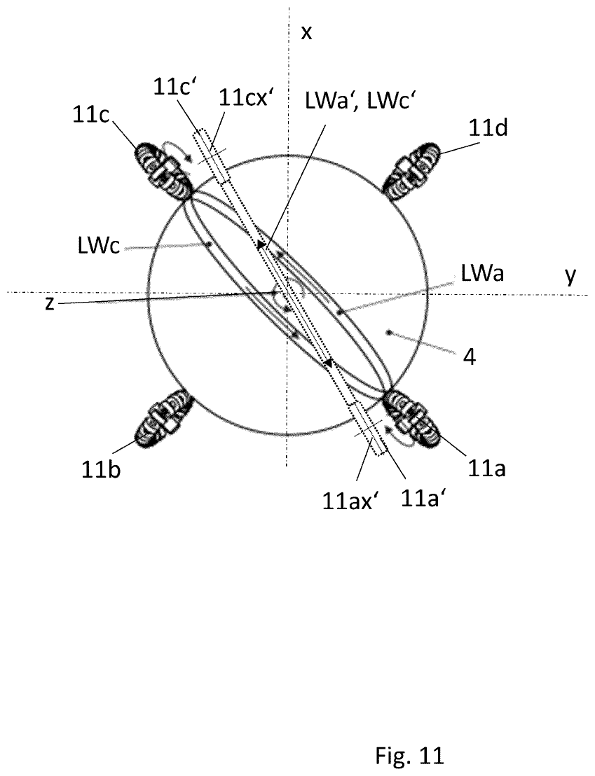

FIG. 11 shows a simplified schematic plan view of the ball 4 with driven omni-wheels 11a, 11b, 11c, 11d. The omni-wheels 11a, 11b, 11c, 11d are each tilted by the angle of tilt γa, γb, γc, γd. The second and third omni-wheel 11b and 11c and the fourth and the first omni-wheels 11d and 11a are therefore located in an X position with respect to each other. The tilting of the non-tilted omni-wheels 11c′ and 11a′, illustrated for comparison purposes, γc and γa is at 0 degrees. The travel paths LWa and LWc of the omni-wheels 11a and 11c, which rotate oppositely to each other, together form an ellipse as seen in relation to the origin of the coordinate system of the ball 4 and to the x-y plane. In this way, a rotating movement of the ball 4 about the axis z can also be effected. In contrast, the travel paths LWa′ and LWc′ of the omni-wheels 11c′ and 11a′ overlap as seen in relation to the origin of the coordinate system of the ball 4 and to the x-y plane and form a straight line. The travel paths LWa′ and LWc′ of the non-tilted omni-wheels 11a′ and 11c′ make possible only linear locomotion of the ball 4.

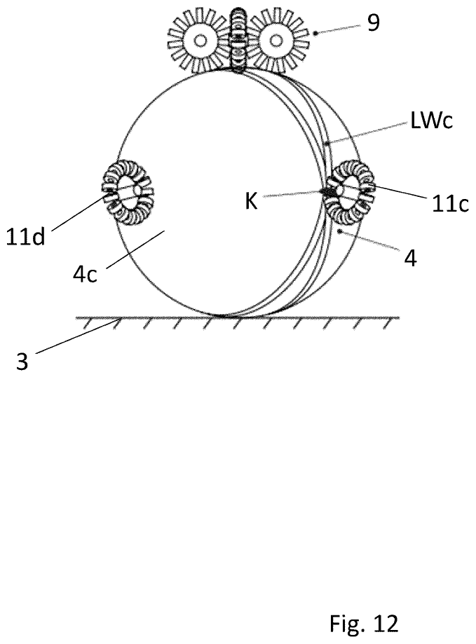

FIG. 12 shows a schematic side view of the ball 4 with the omni-wheels 11c and 11d and the support arrangement 9. The omni-wheels 11c and 11d are illustrated in the positions tilted by the angle of tilt γc, γd so that the travel paths LWc and LWd thereof (not shown) extend via an ellipse about the ball 4. FIG. 8 also shows the contact surface K of the omni-wheel 11c, as formed between the running surface of the omni-wheel 11c and the surface 4c of the ball 4. The support arrangement 9 in this embodiment comprises four non-tilted omni-wheels 9a, 9b, 9c, 9d, the axes of rotation of which extend parallel to the horizontal ground surface 3.

FIG. 13 shows a further schematic side view of the ball 4 with the omni-wheels 11b, 11c and 11d. The vertical axes 11az, 11bz, 11cz, 11dz of the omni-wheels 11a, 11b, 11c, 11d are tilted relative to the vertical axis z of the ball 4 by the angles of tilt γa, γb, γc, γd. The travel paths LWc and LWa of the omni-wheels 11a and 11c thus intersect at the level of the equator 4c. Since both the first omni-wheel 11a and also the third omni-wheel 11c are tilted by the angles of tilt γa and γc, a double γ angle is formed between the travel paths LWa and LWc thereof or between the vertical axes 11az and 11cz thereof.

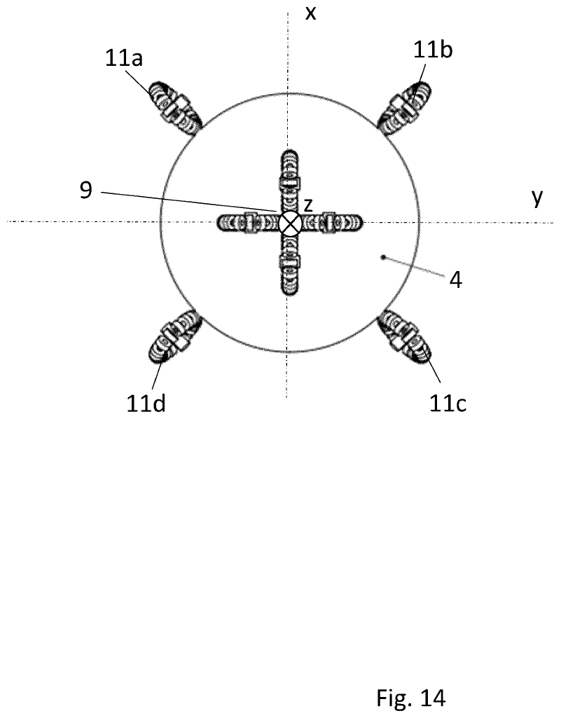

FIG. 14 shows a further schematic plan view of the ball 4 with the omni-wheels 11a, 11b, 11c, 11d and the support arrangement 9. The omni-wheels 11a, 11b, 11c, 11d are tilted by the angles of tilt γa, γb, γc, γd. The omni-wheels 11d and 11a and 11c and 11b are thus located in a so-called X position with respect to each other. The support arrangement 9 comprises four omni-wheels 9a, 9b, 9c, 9d which are uniformly distributed about the vertical axis z of the ball 4.

FIG. 15 shows a simplified diagram of the controller 7 of the vehicle 1. The controller 7 is disposed on and within the carrying element 5. A plurality of components are integrated in the controller 7 in order to be able, on the basis of a balance position of the carrying element 5, to be able to detect weight shifts of the rider 2 and therefore an inclination of the carrying element 5. The degree of inclination and the direction of inclination are detected by a pitch gyroscope 16a, a roll gyroscope 16b and a yaw gyroscope 16c. The gyroscopes 16a, 16b and 16c each provide acceleration and angle data. The pitch gyroscope 16a detects the pivot movement about the transverse axis y, the roll gyroscope 16b about the longitudinal axis x and the yaw gyroscope 16c about the vertical axis z. The control of a direction of rotation about the vertical axis z is effected with the aid of four sensors 10b, 10c, 10d, 10e disposed under the anti-slip overlays 10a on the stand-on surfaces 10 of the carrying element 5. The data detected by the yaw gyroscopes 16a, 16b, 16c and sensors 10b, 10c, 10d, 10e are sent to one of the two evaluation controllers 17a, 17b.

In dependence upon the detected degree of inclination and the direction of inclination, in the first and second evaluation controller 17a, 17b the motor or motors 12a, 12b, 12c and 12d to be driven are actuated specifically in each case via an electronic stability program 18a, 18b, 18c and 18d in the required direction of rotation and speed of rotation in order to produce the desired travel movement of the vehicle 1. At the same time, in parallel, the rider 2 is assisted via a balance control module within the evaluation controller 17a, 17b, the balance position of the stand-on parts 5b of the carrying element 5, which are preferably orientated horizontally, is to be achieved by corresponding actuation of the motors 12a, 12b, 12c and 12d. The evaluation controller 17a, 17b is formed as a programmable microcomputer. The travel movement previously brought about by the rider 2 by the first shift in weight is maintained as long as the rider 2 maintains the inclination of the carrying element 5, and is suspended when the rider 2 shifts his weight in the opposite direction. Undesired control states such as a rotation of the carrying element 5 about the ball 4 when executing a linear movement can also be resolved. In conjunction with steering control modules within the evaluation controller 17a, 17b, a rotation of the carrying element 5 relative to the ball 4 can be induced in a targeted manner so that the rider 2 always remains orientated facing in the direction of travel or, at the end of a steering manoeuvre is again oriented facing in the forwards travel direction.

The actuation of a rotation about the vertical axis z is effected via the yaw gyroscope 16c and the sensors 10b, 10c, 10d, 10e, which register a change in the weight of the toes and/or heels of the feet 2a of the rider 2 acting thereon and send a corresponding signal to the second evaluation controller 17b. Depending on whether the rotation is initiated in the clockwise or anti-clockwise direction, the signal of the z axis is added to the actuation signal of the motors 12a, 12b, 12c, 12d for the x and y axes with a positive sign (z>0) in the case of a clockwise rotation and a negative sign (z<0) in the case of an anti-clockwise rotation. The direction of rotation about the vertical axis z of the ball 4 is determined by a single-sided raising of the toes or of the heel. By raising the right heel or the left toes and consequently relieving the sensors 10d and 10c, which are disposed diagonally with respect to each other, a rotation about the vertical axis z in the anti-clockwise direction is actively controlled. By relieving the sensors 10b and 10e, which are disposed diagonally with respect to each other and which are located below the right toes and the left heel, a rotation about the vertical axis z in the clockwise direction is accordingly actively controlled. If the raising movement and the corresponding detection of the weight changes by the sensors 10d and 10c below the right heel and the left toes or 10b and 10e below the right toes and the left heel takes place at the same time, the rotation in the direction controlled by the foot position is accelerated.

The above-mentioned pitch gyroscope 16a, roll gyroscope 16b and yaw gyroscope 16c are to be understood to be any type of measuring devices, with which the angular positions and angular directions can be determined in relation to the longitudinal axis x, transverse axis y and vertical axis z. These will conventionally be electronic circuits which operate with Piezo sensors. Since the pitch gyroscope 16a, roll gyroscope 16b and yaw gyroscope 16c are respectively disposed at right angles to each other, the position of the carrying element 5, in particular the stand-on parts 5b, in space can be determined.

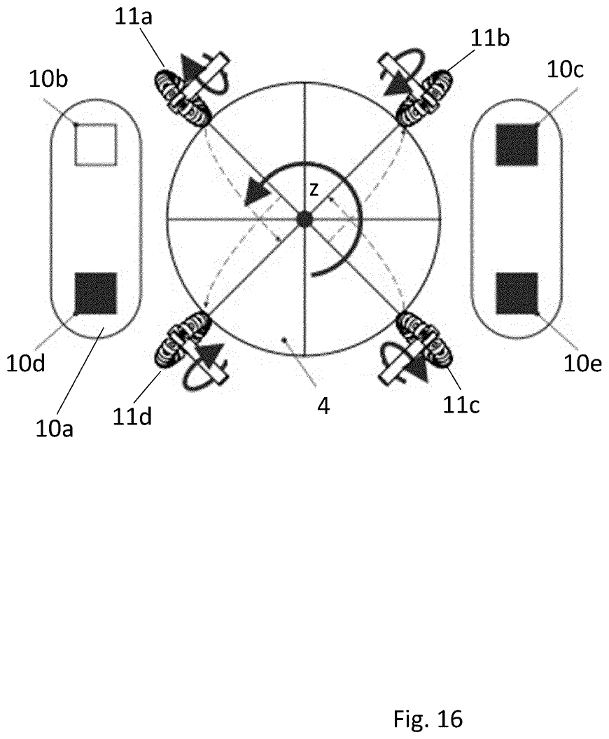

FIG. 16 shows a schematic plan view of the ball 4 with the omni-wheels 11a, 11b, 11c, 11d and the sensors 10b, 10c, 10d, 10e disposed on the stand-on surfaces 10a. The sensors 10c, 10d and 10e register the weight of the right foot 2a of the rider 2 and of his left heel. In contrast, the sensor 10b may register no weight since the left toes of the rider 2 have been raised. After the detected weight change data have been processed in the evaluation controller 17b (see FIG. 15), the rotational movement initiated by the rider 2 about the vertical axis z of the ball 4 is executed in an anti-clockwise direction.

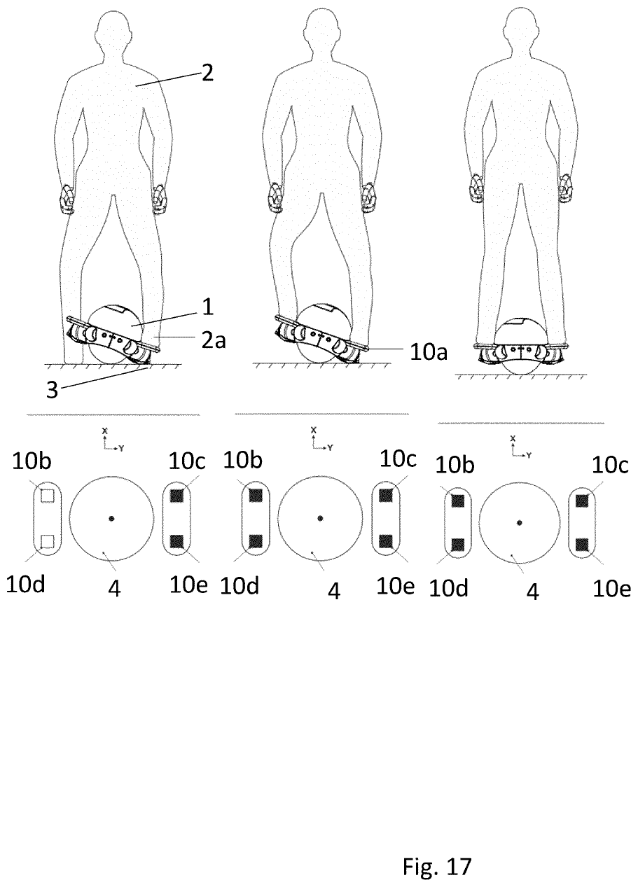

A perspective view of the vehicle 1 of FIG. 1 with positioning of the feet 2a of the rider 2 on the stand-on surfaces 10a of the carrying element 5 during the start-up procedure is shown in FIG. 17. The rider 2 places one foot 2a after the other onto the anti-slip overlays 10a disposed on the stand-on surfaces 10. If one foot 2a is already positioned on a stand-on surface 10 but the other foot 2a is not yet on the ground surface 3, no balancing or locomotion of the vehicle 1 is yet started. Only after all four sensors 10b, 10c, 10d, 10e have registered the presence of both feet 2a of the rider 2 and sent this to the evaluation controller 17a, 17b is the vehicle 2 balanced by a balance control module disposed in the evaluation controller 17a, 17b so that the stand-on surfaces 10 of the carrying element 5 are brought into a horizontal position in space.

1. A vehicle for the locomotion of a rider comprising:
a ball configured for rolling on a ground surface;
a carrying element unstably supported on the ball, on which carrying element the rider stands in a balancing manner during operation of the vehicle;
a drive arrangement supported on the carrying element and which drives the ball; and
a controller, via which the drive arrangement can be controlled in a desired direction of travel in dependence upon the inclination of the carrying element and the direction of inclination of the carrying element;
wherein the drive arrangement comprises four omni-wheels, of which at least two omni-wheels have an angle of tilt, and wherein an angle of elevation between a line that extends from the center point of the ball through an axis of rotation of the respective omni-wheels and the equator of the ball is between −20 and +65 degrees.

2. The vehicle as claimed in claim 1, wherein the angles of tilt of two opposing omni-wheels are co-rotating.

3. The vehicle as claimed in claim 2, wherein all the omni-wheels are tilted by an angle of tilt and the angles of tilt of the adjacent omni-wheels are counter-rotating.

4. The vehicle as claimed in claim 1, wherein all the omni-wheels are tilted by an angle of tilt and the angles of tilt of all the omni-wheels are co-rotating.

5. The vehicle as claimed in claim 1, wherein the angle of tilt relative to a vertical axis of the ball is in the range of −5 to −15 and +5 to +15 degrees.

6. The vehicle as claimed in claim 1, wherein the omni-wheels are folded relative to the longitudinal axis of the ball by a fold angle, and wherein the fold angle is between −110 and +110 degrees, preferably between 0 and 45 degrees.

7. The vehicle as claimed in claim 1, wherein a spacing angle between the omni-wheels is between 80 and 110 degrees, preferably 90 degrees.

8. The vehicle as claimed in claim 1, wherein an angle of elevation between a line that extends from the center point of the ball through an axis of rotation of the respective omni-wheels, and the equator of the ball is between 0 and 45 degrees, preferably 0 degrees.

9. The vehicle as claimed in claim 1, wherein the carrying element reproduces the shape of the ball with a larger diameter.

10. The vehicle as claimed in claim 1, wherein the carrying element comprises a cover part, two stand-on parts and a ring part, the cover part covers the upper part of the ball and the lower part of the ball protrudes downwards out of the ring part.

11. The vehicle as claimed in claim 10, wherein the stand-on parts of the carrying element are disposed substantially at an equator of the ball.

12. The vehicle as claimed in claim 10, wherein stand-on surfaces for the rider are disposed on the stand-on parts, and wherein the stand-on parts with stand-on surfaces are disposed in an opposing manner in relation to the ball.

13. The vehicle as claimed in claim 10, wherein the drive arrangement is attached to the ring part of the carrying element, and the four omni-wheels are each mounted on an axis of rotation.

14. The vehicle as claimed in claim 10, wherein each omni-wheel is driven directly and without interconnection of a transmission via an electric motor, and wherein each electric motor is attached to the ring part of the carrying element.

15. The vehicle as claimed in claim 14, wherein the electric motors are powered via at least one rechargeable battery, and wherein the batteries are disposed in a uniformly distributed manner in the installation space of the carrying element around the circumference of the ball.

16. The vehicle as claimed in claim 1, wherein gyroscopes are disposed on and under the carrying element and are configured to measure the inclination and direction of inclination of the carrying element and transmit the measured inclination and direction of inclination to the evaluation controller.

17. The vehicle as claimed in claim 1, wherein the evaluation controller comprises a balance control module configured to assists the rider in balancing the carrying element in a horizontal position in space.

18. The vehicle as claimed in claim 12, wherein four sensors are disposed on the stand-on surfaces of the carrying element, and wherein the sensors are configured to register the presence of the toes or heels of the feet of the rider and transmit a measured weight change to the evaluation controller.

19. The vehicle as claimed in claim 1, wherein the carrying element is supported on the ball via a support arrangement, and wherein the support arrangement comprises at least one non-driven omni-wheel.

20. The vehicle as claimed in claim 1, wherein the vehicle has no handle.

21. The vehicle as claimed in claim 1, wherein the able of tilt relative to a vertical axis of the ball is between −45 and +45 degrees, wherein the range −2 to +2 degrees is excluded.
